(19) United States
(12) Patent Application Publication
(10) Pub. No.: US 2026/0012992 A1
(43) Pub. Date: Jan. 8, 2026

(54) CAPABILITY SIGNALING FOR LINK RECONFIGURATION RECOMMENDATION

(71) Applicant: Cisco Technology, Inc., San Jose, CA (US)

(72) Inventors: Binita Gupta, San Diego, CA (US); Brian Hart, Sunnyvale, CA (US)

(21) Appl. No.: 19/251,564

(22) Filed: Jun. 26, 2025

Related U.S. Application Data
(60) Provisional application No. 63/668,721, filed on Jul. 8, 2024.

(51) Int. Cl. H04W 76/15; H04W 72/0446

(52) U.S. Cl. CPC H04W 76/15; H04W 72/0446

(57) ABSTRACT

In embodiments described within the disclosure, a method of managing recommended multi-link device reconfigurations includes constructing a management frame, wherein the management frame includes at least a dedicated capability indicator for receiving an access point multi-link device link reconfiguration recommendation, transmitting the management frame, receiving a reconfiguration frame, parsing the reconfiguration frame, and initiating a multi-link reconfiguration procedure associated with the reconfiguration frame.

### CROSS-REFERENCE TO RELATED APPLICATION

This application claims the benefit of priority to U.S. Provisional Application No. 63/668,721, filed Jul. 8, 2024, the disclosure of which is incorporated by reference herein in its entirety.

The present disclosure relates to wireless networking. More particularly, the present disclosure relates to capability signaling for Access Point (AP) Multi-Link Device (MLD) recommendation of links reconfiguration to setup links of a non-Access Point (non-AP) Multi-Link Device (MLD).

### BACKGROUND

Wi-Fi, or wireless fidelity, is of paramount importance in the modern era as a ubiquitous technology that enables wireless connectivity for a wide range of devices. Its significance lies in providing convenient and flexible internet access, allowing seamless communication, data transfer, and online activities. Wi-Fi has become a cornerstone for connectivity in homes, businesses, public spaces, and educational institutions, enhancing productivity and connectivity for individuals and organizations alike.

Over time, the importance of Wi-Fi has evolved in tandem with technological advancements. The increasing demand for faster speeds, greater bandwidth, and improved security has driven the development of more advanced Wi-Fi standards. However, as technology progresses, the demands of Wi-Fi standards and technologies require increasing evolution and innovations in order to provide enhanced performance, increased capacity, and better efficiency.

Specifically, 802.11be defines ML reconfiguration for dynamically adding and/or deleting links from the ML setup/ML association of a non-AP MLD. There are two distinct sub-features defined as part of the ML reconfiguration add/delete links feature: 1) Link reconfiguration to the setup links-ML reconfiguration procedure for adding and deleting links dynamically to the setup links of a non-AP MLD without requiring (re) association between the peer MLDs; and 2) AP MLD recommendation for link reconfiguration-procedure for AP MLD to recommend ML reconfiguration to the setup links of its associated non-AP MLD(s). To avoid inter-op issues, it is important that these two features have separate capability signaling.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a conceptual depiction of a communication layer architecture in accordance with various embodiments of the disclosure, in accordance with various embodiments of the disclosure;

FIG. 3 is a conceptual network diagram of various environments that a reconfiguration capability signaling logic may operate on a plurality of network devices, in accordance with various embodiments of the disclosure;

FIG. 4 is a conceptual illustration of an exemplary MLD Capabilities and Operations Subfield Format, in accordance with various embodiments of the disclosure;

FIG. 5 is a conceptual illustration of an exemplary Extended MLD Capabilities and Operations Subfield Format, in accordance with various embodiments of the disclosure;

FIG. 6 is a flowchart depicting a process for managing capability signaling for multi-link device reconfigurations, in accordance with various embodiments of the disclosure

FIG. 7 is a flowchart depicting a process for managing recommended multi-link device reconfigurations, in accordance with various embodiments of the disclosure;

FIG. 8 is a flowchart depicting a process for managing and acting upon multi-link device capability information, in accordance with various embodiments of the disclosure; and

FIG. 9 is a conceptual block diagram of a device suitable for configuration with a reconfiguration capability signaling logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

### Overview

In some embodiments, a device, includes a processor, at least one network interface controller configured to provide access to a network via a plurality of ports, and a memory communicatively coupled to the processor, wherein the memory includes a reconfiguration capability signaling logic. The logic is configured to receive a management frame, extract a dedicated capability indicator for receiving an access point multi-link device link configuration recommendation from the management frame, update an internal record, identify a potential need for multi-link reconfiguration, access the record capability indication of a specific non-access point multi-link device, formulate a link reconfiguration frame, and transmit the link reconfiguration frame.

In some embodiments, a method of managing recommended multi-link device reconfigurations includes constructing a management frame, wherein the management frame includes at least a dedicated capability indicator for receiving an access point multi-link device link reconfiguration recommendation, transmitting the management frame, receiving a reconfiguration frame, parsing the reconfiguration frame, and initiating a multi-link reconfiguration procedure associated with the reconfiguration frame.

### Example Embodiments

802.11be defines ML reconfiguration optional for adding and deleting links to the setup links of a non-AP MLD. ML Reconfiguration may be achieved by a non-AP MLD sending a Link Reconfiguration Request frame and the AP MLD responding with a Link Reconfiguration Response frame. This results in the non-Access Point (non-AP) Multi-Link Device (MLD) and the Access Point (AP) Multi-Link Device (MLD) being out of sync in terms of setup links for that non-Access Point (non-AP) Multi-Link Device (MLD). It is important to solve this error case for robust operation of Multi-Link (ML) Reconfiguration add/delete links feature. In response to the issues described above, devices and methods are discussed herein to address a gap for Multi-Link (ML) Reconfiguration add/delete links operation when a current link is being deleted to avoid an Access Point (AP) Multi-Link Device (MLD) and a non-Access Point (non-AP) Multi-Link Device (MLD) becoming out of sync with regard to their state for the setup links.

In general, wireless networking standards such as 802.11be may define optional multi-link (ML) reconfiguration for adding and deleting links to the setup links of a non-access point multi-link device (non-AP MLD). For example, a non-AP MLD could perform various ML reconfiguration operations. Such operations may include adding a new link, such as by changing from a single link A to a combination of links A and B, or adding multiple new links, such as by changing from link A to a combination of links A, B, and C. In certain embodiments, the operations may involve deleting a current link while adding one or more new links, such as by changing from link A to link B, or from link A to a combination of links B and C. It is also contemplated that the operation may involve modifying an existing multi-link setup, such as by changing from links A and B to links B and C, which involves deleting the current link A while adding a new link C.

In additional embodiments, ML Reconfiguration may be achieved by a non-AP MLD sending a Link Reconfiguration Request frame and the AP MLD responding with a Link Reconfiguration Response frame. In the ML Reconfiguration operations where the current link is being deleted and replaced by one or more other links, as in the latter examples above, there may be an error possibility that the transaction does not get completed. For instance, a typical transaction may involve a first step where a non-AP MLD sends a Link Reconfiguration Request frame on a first link, a second step where the AP MLD sends an acknowledgment (ACK) for the request on the first link, a third step where the AP MLD sends a Link Reconfiguration Response frame on the first link, and a fourth step where the non-AP MLD sends an ACK for the response on the first link.

In embodiments where the final ACK frame from the non-AP MLD is lost and is not received by the AP MLD, the AP MLD may retry sending the Link Reconfiguration Response frame on the original link. However, because the non-AP MLD may have already processed the initial response and ceased operating on that link as part of the deletion process, it may not receive the retried frame. This may result in the non-AP MLD and the AP MLD becoming out of sync in terms of their understanding of the active setup links for that non-AP MLD. It is important to solve this error case to ensure robust operation of the Multi-Link Reconfiguration add/delete links feature.

In many embodiments, to resolve this issue, an AP MLD may be allowed to send a Link Reconfiguration Response frame over other links. For example, the ML Reconfiguration feature may be enhanced such that in scenarios where a link reconfiguration results in a non-AP MLD deleting its current link, if the AP MLD does not get an ACK for its Link Reconfiguration Response frame, it can choose to send the Link Reconfiguration Response frame on one or more of the new setup links that were indicated as successfully added. The Link Reconfiguration Response frame sent on other links may have the same Dialog Token as the one received in the corresponding Link Reconfiguration Request frame to ensure the messages are correctly associated. In additional embodiments, the AP MLD may decide to send the Link Reconfiguration Response frame on a newly added link where it has already received another frame from the non-AP MLD, as this may indicate that the non-AP MLD is active on that link.

In still additional embodiments, when a non-AP MLD receives a Link Reconfiguration Response frame on a new or different link, it may check for a matching Dialog Token to associate it with a Link Reconfiguration Request frame that it had sent previously on another link. Upon finding a match, the non-AP MLD may send an ACK for that frame on the new link. When the AP MLD receives this ACK, it can confirm the transaction is complete and update its internal records for the non-AP MLD's setup links. As a result, both the AP MLD and non-AP MLD may achieve the same, synchronized state for the setup links.

In various embodiments, a specific behavior may be defined for the AP MLD and the non-AP MLD. An AP MLD may send the Link Reconfiguration Response frame on the same link where the corresponding Link Reconfiguration Request frame was received, except in the specific failure case. For example, if the AP MLD does not receive an acknowledgement for a Link Reconfiguration Response frame that requested deletion of the link where the frame exchange occurred, and the link deletion was otherwise successful, then the AP MLD may also send the same Link Reconfiguration Response frame on any of the new setup links that were indicated as successfully added. Similarly, if a non-AP MLD receives a Link Reconfiguration Response frame on a different link than the link where the corresponding request was sent, as identified by a matching Dialog Token, it may send an acknowledgement for that frame.

In other additional embodiments, an “ML Reconfig Switch Time” field may be added in the Link Reconfiguration Response frame. This field may indicate a future time when the new set of setup links become active. This may ensure that the non-AP MLD remains on the current link for a bit longer, allowing any error scenarios where an AP MLD retries the Link Reconfiguration Response frame on the current link to be handled by the non-AP MLD, which can then send an ACK for the retried frame. The ‘ML Reconfig Switch Time’ field can indicate a switch time for the ML reconfiguration in various units, such as Time Units (TUs), where one TU may equal 1024 microseconds, or as a power of two multiple or sub-multiple of a TU, or in milliseconds.

For example, the ‘ML Reconfig Switch Time’ field can be included at the end of the Link Reconfiguration Response frame, perhaps encapsulated in its own sub-element. Alternatively, the new field can be included in any other place in the frame or as part of another existing field or element. In still additional embodiments, the non-AP MLD can also indicate its preference for an ‘ML Reconfig Switch Time’ in the Link Reconfiguration Request frame. The AP MLD can then indicate the same ‘ML Reconfig Switch Time’ in its response, or it may provide a different time if its own operational needs require it.

In many further embodiments, an AP MLD may send a BSS Transition Management (BTM) Request to reinitiate the ML Reconfiguration procedure. For example, if the AP MLD does not get an ACK for the Link Reconfiguration Response frame after some retries, it may assume an error has occurred and can send a BTM Request frame on both the old and/or new set of setup links indicating the desired set of links. This BTM Request frame can be enhanced, for example by using a reserved bit in the Request Mode, to indicate that an ‘ML Reconfig Requested’ is being made.

If, based on its local state, the non-AP MLD is already operating on the suggested set of setup links received in the BTM Request, it can take one or more actions. For example, in many embodiments, it may assume the previous ML Reconfiguration operation did not succeed at the AP and revert its setup links to the old set of links and re-perform the same operation. In other instances, it may send a BTM Response frame with a new BTM Status Code to indicate that the non-AP MLD is “already operating on suggested setup links”. The AP MLD can take that as an indication that the previous ML Reconfiguration was successful at the non-AP MLD and update its own setup links for that non-AP MLD. Alternatively, a non-AP MLD could send a BTM Response with “Accept,” which could also signal to the AP MLD that the previous reconfiguration was successful.

In still additional embodiments, the ML Reconfiguration procedure itself may be enhanced to support a ‘report’ setup link operation, in addition to add and delete link operations. A non-AP MLD can initiate an ML Reconfiguration procedure by sending a Link Reconfiguration Request frame that reports the current state of its setup links. This request may be sent using protected management frames for security. The AP MLD can then update its state to match that of the non-AP MLD. The AP MLD may then respond with a Link Reconfiguration Response frame that indicates SUCCESS for each of the setup links reported by the non-AP MLD. It should be understood that any of the foregoing examples may address the out-of-sync state between the AP MLD and the non-AP MLD.

In certain embodiments, a non-AP MLD may send a frame with a Power Management (PM) bit set to zero on one of the newly added links. For example, after sending an ACK for the Link Reconfiguration Response frame that deletes the current link, the non-AP MLD may send another frame, such as a QoS Null frame, with PM=0 on any of the newly added links soon after. If the reconfiguration changes the link from A to B, the non-AP MLD may send the frame on link B. If the change is from A to links B and C, it may send the frame on either B or C. In general, it is envisioned that the frame signaling PM=0 is sent as a protected frame. This may signal to the AP MLD that the ML Reconfiguration operation was completed successfully at the non-AP MLD, allowing the AP MLD to update its setup links accordingly, even if the original ACK was lost.

In some embodiments, as a last resort, the AP MLD may disassociate the non-AP MLD. If the AP MLD does not receive an ACK for the Link Reconfiguration Response frame after some retries, it may assume a persistent error condition has occurred and may disassociate the non-AP MLD by sending a Disassociation frame over both the old and the new set of links. In such a case, the non-AP MLD would have to reassociate with the AP MLD to re-establish a connection.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

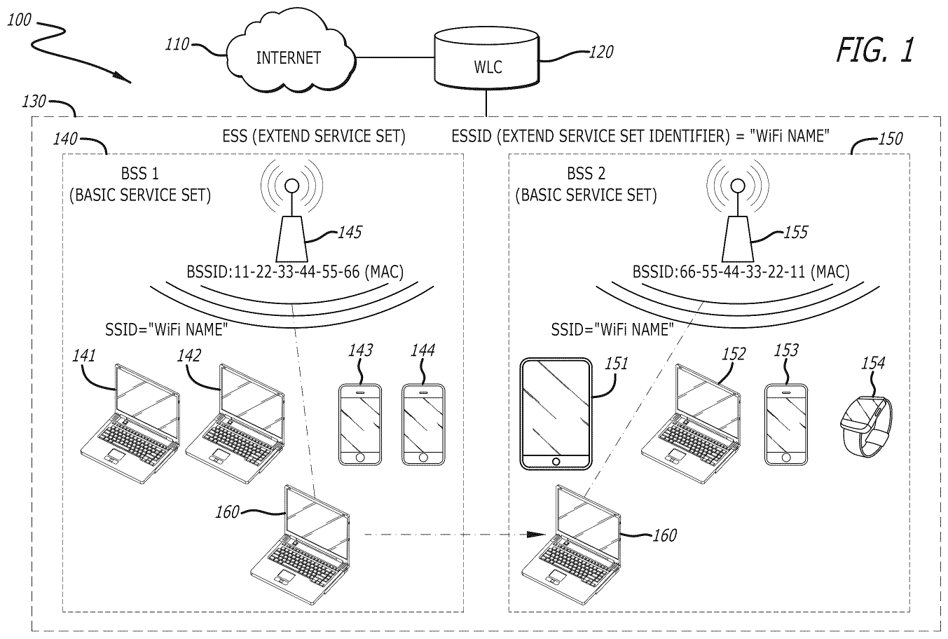

Referring to FIG. 1, a schematic block diagram of a wireless local networking system 100, in accordance with various embodiments of the disclosure is shown. The wireless local networking system 100 can be configured to provide network access to a plurality of devices. In many embodiments, the wireless local networking system 100 can be connected to a broader network, such as the Internet 110, potentially through a Wireless LAN Controller (WLC 120) or other gateway device. The WLC 120 can serve as a centralized point of administration for managing network policies and access points within the wireless local networking system 100. The overall network made available to end-user devices can be represented as an Extended Service Set (ESS 130), which can be identified by an Extended Service Set Identifier (ESSID), such as “WiFi NAME”.

In a number of embodiments, the ESS 130 can be composed of one or more Basic Service Sets (BSSs) that work together to provide broader, seamless network coverage. As depicted in the embodiment shown in FIG. 1, the ESS 130 can comprise a first BSS 140 and a second BSS 150. Each BSS can be managed by a corresponding access point (AP), such as a first access point 145 for the first BSS 140 and a second access point 155 for the second BSS 150. It is contemplated that each BSS can be uniquely identified by a Basic Service Set Identifier (BSSID), which is often the Media Access Control (MAC) address of its respective access point. For example, the first BSS 140 can have a BSSID of “Nov. 22, 1933-44-55-66”, while both BSSs can share the same human-readable Service Set Identifier (SSID) of “WiFi NAME” to present a single, unified network to users.

In more embodiments, a variety of user end devices, which can also be referred to as stations (STAs), may connect to the network through the access points. The first BSS 140 can provide wireless connectivity to a number of devices associated with the first access point 145. For instance, these devices can include a first notebook 141, a second notebook 142, a first phone 143, and a second phone 144. These devices may communicate with each other and access resources on the Internet 110 through their connection to the first access point 145.

In further embodiments, the second BSS 150 can similarly provide connectivity to another set of devices that are associated with the second access point 155. These user devices can include a first tablet 151, a fourth notebook 152, a third phone 153, and a first watch 154. The presence of diverse device types in both the first BSS 140 and the second BSS 150 can illustrate a typical wireless environment where multiple users with different kinds of equipment connect to the same wireless network infrastructure.

In additional embodiments, the wireless local networking system 100 can support more advanced operations such as multi-link communication and client roaming. For example, a third notebook 160 is depicted as being capable of communicating with both the first access point 145 and the second access point 155. This can represent a Multi-Link Device (MLD) that may maintain simultaneous connections to different access points or on different frequency bands to improve performance or reliability. In the context of the present disclosure, a device like the third notebook 160 may be a non-AP MLD that can benefit from link reconfiguration recommendations sent by an AP MLD (which could be represented by the coordinated operation of the first access point 145 and the second access point 155) to optimize its connections.

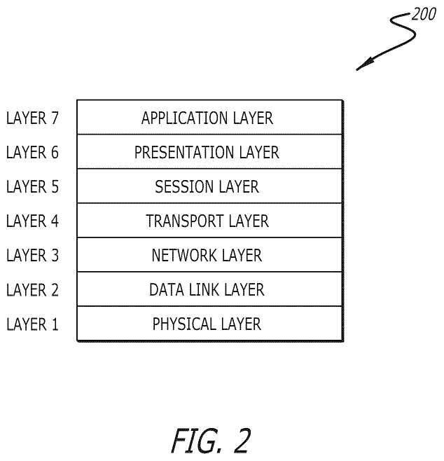

Although a specific embodiment for a wireless local networking system 100 for carrying out the various steps, processes, methods, and operations described herein is discussed with respect to FIG. 1, any of a variety of systems and/or devices may be utilized in accordance with embodiments of the disclosure. For example, while a WLC 120 is shown, in other network architectures the access points could operate in a standalone mode or be managed by a cloud-based controller. The elements depicted in FIG. 1 may also be interchangeable with other elements of FIGS. 2-9 as required to realize a particularly desired embodiment.

Referring to FIG. 2, a conceptual depiction of a communication layer architecture 200, in accordance with various embodiments of the disclosure is shown. This layered model, which can be configured as the Open Systems Interconnection (OSI) model, can illustrate how different networking functions are encapsulated and organized to facilitate communication between devices. Each layer can be responsible for specific tasks, interacting with the layers directly above and below it.

In many embodiments, the communication layer architecture 200 can include a first physical layer. The physical layer can be responsible for the transmission and reception of raw, unstructured data bits over a physical medium. It can define the electrical, mechanical, and procedural characteristics of the hardware, including cables, connectors, signaling, and modulation techniques for wireless transmissions. For instance, the wireless standards that govern Wi-Fi communication can operate at this layer, defining the radio frequencies and methods used to send the frames discussed in the present disclosure over the air.

In a number of embodiments, the communication layer architecture 200 can include a second data link layer. This layer can be primarily concerned with the reliable transfer of data frames between two directly connected nodes on the same network. Its responsibilities can include media access control, physical addressing (MAC addresses), framing, and error detection. The core concepts of the present disclosure can operate at this layer; for example, the construction of a management frame containing a dedicated capability indicator, and the transmission and reception of a Link Reconfiguration Notify frame, can all be functions managed at the data link layer.

In more embodiments, the communication layer architecture 200 can include a third network layer. The network layer can be responsible for establishing end-to-end communication across interconnected networks, a process known as routing. Its primary functions can include logical addressing (e.g., Internet Protocol or IP addresses), route determination, and the fragmentation and reassembly of data packets for transmission across different networks. While the capability signaling described herein can occur at the data link layer, the user data flows that ultimately benefit from an optimized multi-link configuration can be routed at the network layer.

In further embodiments, the communication layer architecture 200 can include a fourth transport layer. This layer can provide for the reliable and orderly delivery of data between processes running on host machines. It is contemplated that the transport layer can manage functions such as error detection and correction, flow control, and segmentation of data into smaller pieces for transmission. The choice of transport protocol, such as the reliable Transmission Control Protocol (TCP) or the faster User Datagram Protocol (UDP) often used for latency-sensitive applications, can inform an AP MLD's analysis of link performance data when determining if a link reconfiguration recommendation is necessary.

In additional embodiments, the communication layer architecture 200 can include a fifth session layer. The session layer can be configured to manage and control the communication dialogues, or sessions, between applications on different devices. Its responsibilities can include establishing, maintaining, and terminating these sessions. For example, a persistent session for a real-time application like video conferencing would rely on the underlying links being stable and performant, which can create the need for the dynamic link reconfiguration mechanisms described in the present disclosure.

In still more embodiments, the communication layer architecture 200 can include a sixth presentation layer. The presentation layer can focus on the representation and translation of data, ensuring that information sent from the application layer of one system can be understood by the application layer of another system. It can handle tasks such as data format conversion, character set translation, data compression, and encryption. For instance, data for real-time applications is often compressed using video or audio codecs, and this layer can be responsible for managing that data representation before it is sent over the network links.

In yet further embodiments, the communication layer architecture 200 can include a seventh application layer. This layer can serve as the direct interface between the network and the software applications that end-users interact with. It can encompass a wide variety of protocols that support functions such as web Browse (HTTP), file transfers (FTP), and real-time communication. The ultimate goal of the link reconfiguration recommendations discussed herein can be to improve the performance and Quality of Service for applications operating at this layer.

Although a specific embodiment for a communication layer architecture 200 for carrying out the various steps, processes, methods, and operations described herein is discussed with respect to FIG. 2, any of a variety of systems and/or devices may be utilized in accordance with embodiments of the disclosure. For example, in some network models, the functions of the Session Layer and Presentation Layer may be combined or handled directly by the Application Layer, rather than being distinct layers. The elements depicted in FIG. 2 may also be interchangeable with other elements of FIGS. 1 and FIGS. 3-9 as required to realize a particularly desired embodiment.

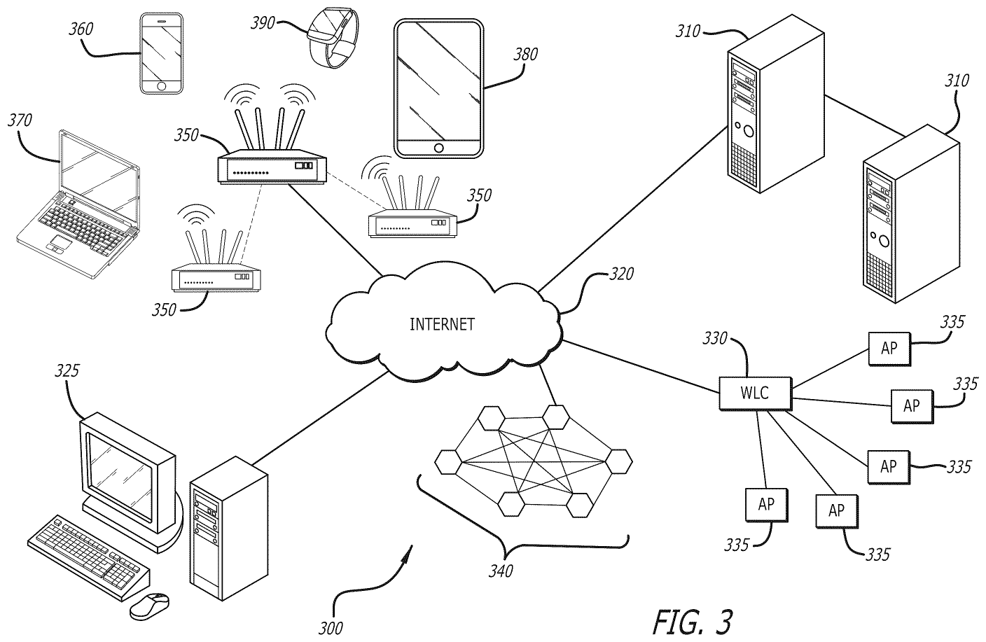

Referring to FIG. 3, a conceptual network diagram 300 of various environments that a reconfiguration capability signaling logic may operate on a plurality of network devices, in accordance with various embodiments of the disclosure is shown. The diagram illustrates that the reconfiguration capability signaling logic can be deployed in a variety of hardware and software configurations to carry out the methods and processes described herein. In many embodiments, the logic can be implemented as a standalone device, integrated within other network hardware, or operated as a distributed service across multiple devices, all of which may be interconnected via a communication network 320, such as the Internet.

In a number of embodiments, the reconfiguration capability signaling logic can be deployed in a centralized or cloud-based architecture. For example, a reconfiguration servers 310 can be configured to host the reconfiguration capability signaling logic. These servers may operate as part of a cloud computing service, providing management and analysis capabilities for one or more remote networks, such as a deployed network 340. This centralized approach can allow for scalable policy enforcement and analytics for the link reconfiguration recommendation features across geographically dispersed networks.

In more embodiments, the reconfiguration capability signaling logic can be integrated within a dedicated network management device. For instance, a wireless LAN controller (WLC 330) can have an integrated reconfiguration capability signaling logic that it can use to monitor and control a plurality of connected access points. As depicted, the WLC 330 can manage a plurality of access points 335. It is contemplated that a personal computer 325 may be utilized by a network administrator to access and configure the logic operating on the WLC 330 or on the servers.

In further embodiments, the reconfiguration capability signaling logic may be operated as a distributed service across multiple network devices at the edge of a network. For example, a plurality of access points 350 can each operate an instance of the reconfiguration capability signaling logic. In such a distributed arrangement, one of the access points may be designated to act as a primary for its local group, or they may operate collaboratively to manage link reconfiguration recommendations for connected client devices.

In additional embodiments, the various end-user devices can also operate an instance of the reconfiguration capability signaling logic. These devices, which can act as non-AP MLDs, can include a cellular phone 360, a laptop computer 370, a portable tablet computer 380, and a wearable computing device 390. On these devices, the reconfiguration capability signaling logic can be configured to perform the non-AP MLD functions described herein, such as evaluating internal capabilities and constructing management frames that include the dedicated capability indicator for link reconfiguration recommendations.

Although a specific embodiment for various environments that the reconfiguration capability signaling logic may operate on for carrying out the various steps, processes, methods, and operations described herein is discussed with respect to FIG. 3, any of a variety of systems and/or processes may be utilized in accordance with embodiments of the disclosure. For example, the reconfiguration capability signaling logic could also be deployed within a network switch or router, managing policies for both wired and wireless devices. The elements depicted in FIG. 3 may also be interchangeable with other elements of FIGS. 1-2 and FIGS. 4-9 as required to realize a particularly desired embodiment.

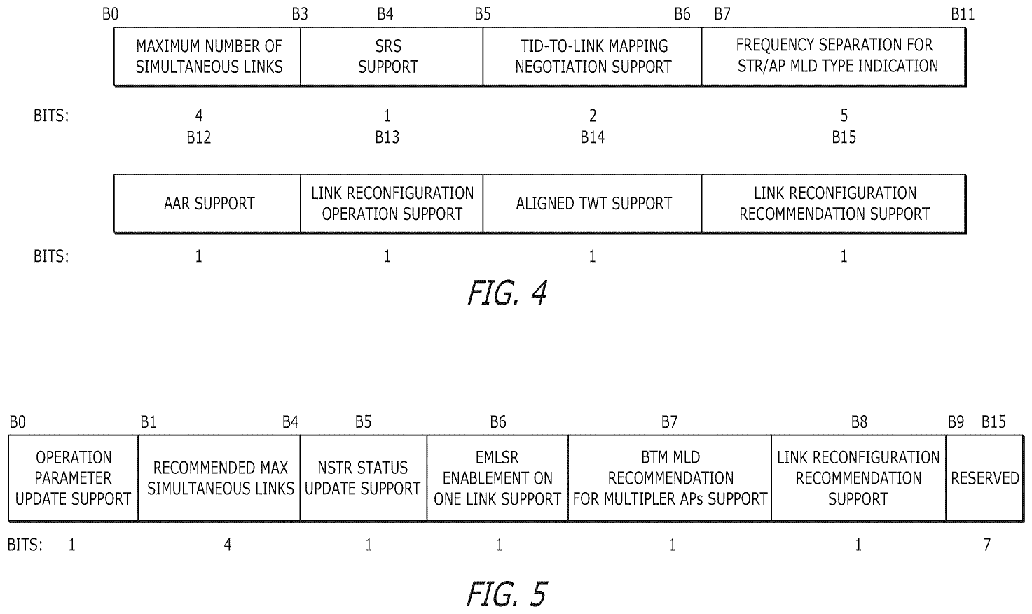

Referring to FIG. 4, a conceptual illustration of an exemplary MLD Capabilities and Operations Subfield Format, in accordance with various embodiments of the disclosure is shown. This format can illustrate one embodiment of how a Multi-Link Device (MLD) may signal its various operational capabilities to other devices within a wireless network. In many embodiments, this subfield can be included within a larger management frame, such as a Basic Multi-Link element, that can be exchanged between devices to establish and maintain communication parameters. The structure of the subfield can span a specific number of bits, such as from B0 through B15, and may be organized into one or more rows for logical grouping of the various capabilities.

In a number of embodiments, this subfield format can be configured to provide separate and distinct signaling for different types of reconfiguration capabilities. For instance, a “Link Reconfiguration Operation Support” field, shown at bit B13, can indicate a device's general support for multi-link reconfiguration operations that it may initiate itself. Critically, a dedicated capability indicator for receiving an access point multi-link device link reconfiguration recommendation can be provided in a separate field, such as the “Link Reconfiguration Recommendation Support” field shown at bit B15. This dedicated capability indicator can therefore be distinct from the second capability indicator for general multi-link reconfiguration operations, which can allow a receiving device to unambiguously determine if the MLD supports AP-initiated recommendations.

In more embodiments, the first row of the subfield format, which can span from bit B0 to B11, may encompass several other capability fields. For example, a field for “Maximum Number Of Simultaneous Links,” which can occupy four bits, may indicate the MLD's capacity for concurrent link operation. An “SRS Support” field at bit B4 may signal support for Sounding Reference Signal procedures, while a two-bit “TID-To-Link Mapping Negotiation Support” field at bits B5 and B6 may indicate if the MLD can negotiate mappings between Traffic Identifiers and specific links. A five-bit field for “Frequency Separation For STR/AP MLD Type Indication,” from B7 to B11, could provide information related to simultaneous transmit and receive operations or the MLD type.

In further embodiments, the second row of the subfield can include other support indicators in addition to the reconfiguration capabilities. For example, an “AAR Support” field at bit B12 may indicate support for certain acknowledgment and retransmission mechanisms. An “Aligned TWT Support” field at bit B14 could indicate support for Aligned Target Wake Time operations, which can be relevant for coordinating power-saving schedules among devices.

In additional embodiments, a device's reconfiguration capability signaling logic can be configured to construct a management frame containing this MLD Capabilities and Operations subfield. The logic can set the “Link Reconfiguration Recommendation Support” bit (B15) to signify its specific support for receiving recommendations. An AP MLD that receives this frame can extract this dedicated capability indicator and store it in its multi-link device capability data, allowing it to later validate this specific support before formulating and transmitting a Link Reconfiguration Notify frame.

Although a specific embodiment for an MLD Capabilities and Operations Subfield Format for carrying out the various steps, processes, methods, and operations described herein is discussed with respect to FIG. 4, any of a variety of systems and/or devices may be utilized in accordance with embodiments of the disclosure. For example, the specific bit assignments for capabilities like ‘AAR Support’ or ‘SRS Support’ could be placed in different locations within the subfield in other embodiments of a standard. The elements depicted in FIG. 4 may also be interchangeable with other elements of FIGS. 1-3 and FIGS. 5-9 as required to realize a particularly desired embodiment.

Referring to FIG. 5, a conceptual illustration of an exemplary Extended MLD Capabilities and Operations Subfield Format, in accordance with various embodiments of the disclosure is shown. This format can represent an alternative or additional method for a Multi-Link Device (MLD) to signal a more extensive set of capabilities to other devices within a wireless network. In many embodiments, this extended subfield can be included within a management frame, such as a Basic Multi-Link (ML) element or a Reconfiguration ML element, that is transmitted between devices. The subfield format may span a specific number of bits, for example from B0 to B15, with various bits allocated to different support features.

In a number of embodiments, this extended subfield format can provide a specific location to signal novel reconfiguration capabilities. For example, a dedicated capability indicator for receiving an access point multi-link device link reconfiguration recommendation can be included by using a reserved bit within this subfield format. As depicted, bit B8 can be designated for “Link Reconfiguration Recommendation Support,” providing an explicit, one-bit field for an MLD to advertise its support for this specific feature. This allows for the capability to be signaled distinctly from other general reconfiguration capabilities, which can aid in preventing interoperability issues.

In more embodiments, the extended subfield format can include a variety of other capability indicators. For example, at bit B0, an “Operation Parameter Update Support” field may signal that the device supports procedures for updating certain operational parameters. A four-bit field for “Recommended Max Simultaneous Links,” which can span from B1 to B4, may allow a device to indicate a preferred maximum number of links for concurrent multi-link operation. It is contemplated that other fields may also be present, such as an “NSTR Status Update Support” field at bit B5 and an “EMLSR Enablement On One Link Support” field at bit B6, which could relate to non-simultaneous transmit and receive operations and Enhanced Multi-Link Single Radio features, respectively.

In further embodiments, the extended subfield can define capabilities related to network transitions and management. For instance, a “BTM MLD Recommendation For Multiple APs Support” field at bit B7 can indicate support for BSS Transition Management (BTM) recommendations that may involve multiple APs. The subfield can also include a “Reserved” field, which, as shown, may occupy bits B9 through B15. These seven reserved bits can be set aside for future capabilities or other functions that may be defined in later versions of a wireless communication standard.

In additional embodiments, a device's reconfiguration capability signaling logic can be configured to construct a management frame containing this Extended MLD Capabilities and Operations subfield. The logic can set the “Link Reconfiguration Recommendation Support” bit (B8) based on the state of an internal configuration parameter, such as a Management Information Base (MIB) variable. When another device receives this frame, its logic can extract this dedicated capability indicator and update an internal record to reflect that the transmitting device supports receiving AP MLD recommendations.

Although a specific embodiment for an Extended MLD Capabilities and Operations Subfield Format for carrying out the various steps, processes, methods, and operations described herein is discussed with respect to FIG. 5, any of a variety of systems and/or devices may be utilized in accordance with embodiments of the disclosure. For example, the four bits allocated for ‘Recommended Max Simultaneous Links’ could instead be used as four separate one-bit flags for different, unrelated capabilities in an alternative embodiment. The elements depicted in FIG. 5 may also be interchangeable with other elements of FIGS. 1-4 and FIGS. 6-9 as required to realize a particularly desired embodiment.

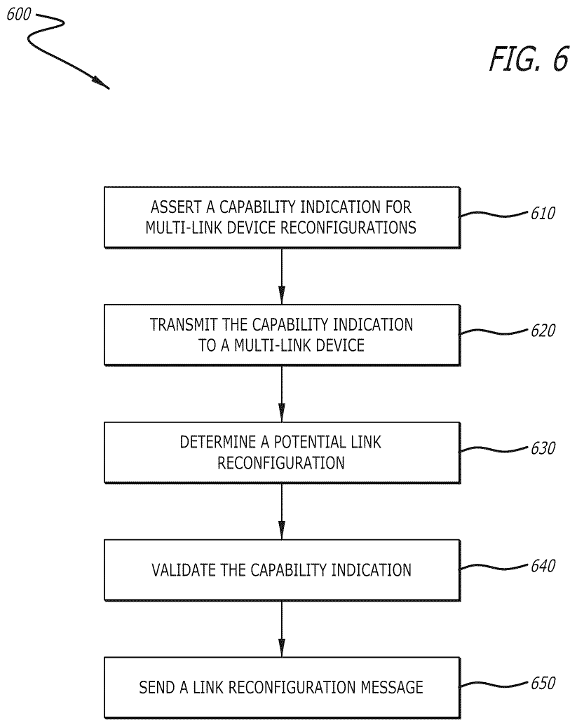

Referring to FIG. 6, a flowchart depicting a process 600 for managing capability signaling for multi-link device reconfigurations, in accordance with various embodiments of the disclosure is shown. In many embodiments, the process 600 can assert a capability indication for multi-link device reconfigurations (block 610). For instance, the asserted capability indication can be a dedicated capability indicator that is distinct from a second capability indicator for general multi-link reconfiguration operations. In some embodiments, this dedicated capability indicator can signify support for receiving an access point multi-link device link reconfiguration recommendation.

In a number of embodiments, the process 600 can transmit the capability indication to a multi-link device (block 620). It is contemplated that this transmission may be accomplished by constructing and transmitting a management frame that comprises the dedicated capability indicator. For example, the dedicated capability indicator can be located within a Multi-Link Device (MLD) Capabilities and Operations subfield or, in certain embodiments, within an Extended Multi-Link Device (MLD) Capabilities and Operations subfield of the management frame.

In more embodiments, the process 600 can determine a potential link reconfiguration (block 630). This determination can involve an Access Point Multi-Link Device (AP MLD) identifying a potential need for multi-link reconfiguration for an associated non-AP MLD. For instance, this identification of a potential need can be based on an analysis of link performance data, which may include metrics related to network traffic, link quality, or other performance characteristics.

In further embodiments, the process 600 can validate the capability indication (block 640). For example, an AP MLD can perform this validation by extracting the dedicated capability indicator for receiving an access point multi-link device link configuration recommendation from a received management frame. It is contemplated that the validation can also involve accessing an internal record where the capability indication of a specific non-AP MLD was previously stored.

In additional embodiments, the process 600 can send a link reconfiguration message (block 650). The link reconfiguration message that is sent can be a Link Reconfiguration Notify frame. In some embodiments, the transmission of the link reconfiguration frame may occur only if it is determined that the capability indication confirms that the target device supports the identified reconfiguration recommendations.

Although a specific embodiment for a process 600 for managing capability signaling for multi-link device reconfigurations for carrying out the various steps, processes, methods, and operations described herein is discussed with respect to FIG. 6, any of a variety of systems and/or devices may be utilized in accordance with embodiments of the disclosure. For example, the validation of the capability indication could be performed by different network entities, such as a centralized Wireless LAN Controller (WLC) on behalf of an AP MLD, or directly by the AP MLD itself. The elements depicted in FIG. 6 may also be interchangeable with other elements of FIGS. 1-5 and FIGS. 7-9 as required to realize a particularly desired embodiment.

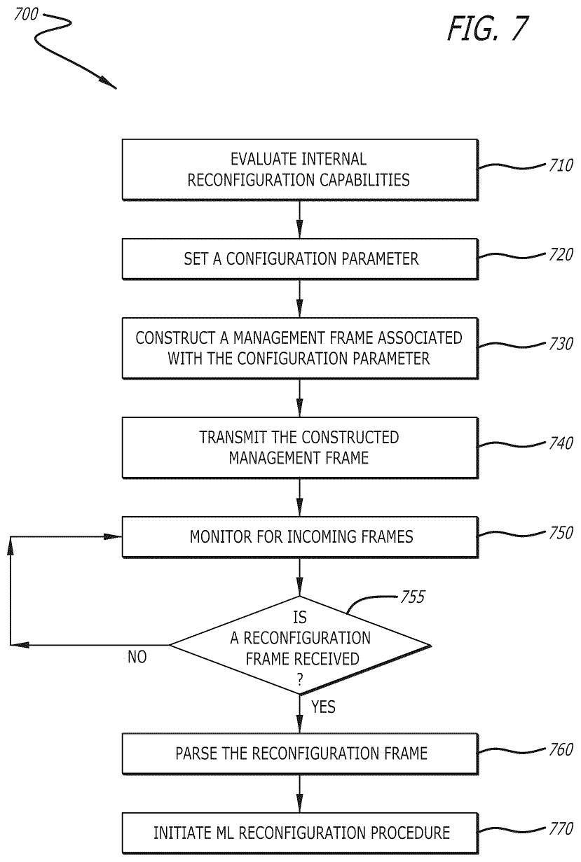

Referring to FIG. 7, a flowchart depicting a process 700 for managing recommended multi-link device reconfigurations, in accordance with various embodiments of the disclosure is shown. In many embodiments, the process 700 can evaluate internal reconfiguration capabilities (block 710). This evaluation can involve a device determining its specific ability to support various multi-link reconfiguration features before advertising them. For example, the evaluation can specifically determine if the device has the capability to process a received access point multi-link device link reconfiguration recommendation.

In a number of embodiments, the process 700 can set a configuration parameter (block 720). This parameter can be set based on the outcome of the prior evaluation of the device's internal capabilities. It is contemplated that the configuration parameter can be a Management Information Base (MIB) variable, which can reflect the device's support for receiving link reconfiguration recommendations.

In more embodiments, the process 700 can construct a management frame associated with the configuration parameter (block 730). The constructed management frame can comprise at least a dedicated capability indicator for receiving an access point multi-link device link reconfiguration recommendation. For instance, this dedicated capability indicator can be configured to be distinct from a second capability indicator for general multi-link reconfiguration operations, thereby preventing ambiguity in the device's signaled capabilities.

In further embodiments, the process 700 can transmit the constructed management frame (block 740). This transmission can occur during an association handshake with an AP MLD, ensuring the AP MLD is immediately aware of the device's specific capabilities. It is contemplated that the management frame can also be transmitted in response to a probe request or as part of a periodic capability update.

In additional embodiments, the process 700 can monitor for incoming frames (block 750). The monitoring can occur on a plurality of ports associated with one or more of the device's network interface controllers. This monitoring can be a passive listening process, where the device waits for specific types of management frames, such as recommendations from an AP MLD.

In still more embodiments, the process 700 can determine if a reconfiguration frame is received (block 755). If a reconfiguration frame is not received, then the process 700 can once again monitor for incoming frames (block 750). However, if a reconfiguration frame is received, then the process 700 can parse the reconfiguration frame (block 760). The received reconfiguration frame can specifically be a Link Reconfiguration Notify frame sent by an AP MLD. For instance, the determination could involve filtering incoming frames based on frame type or the sender's address to identify valid reconfiguration frames.

In yet further embodiments, the process 700 can parse the reconfiguration frame (block 760). Parsing can involve extracting the recommended link changes, such as which links to add and/or which links to delete from the current link setup. This process can also include validating the source of the frame and ensuring it is an authorized and authenticated AP MLD before proceeding.

In still additional embodiments, the process 700 can initiate a multi-link reconfiguration procedure (block 770). This initiation can be associated with the parsed reconfiguration frame, where the device begins the process of adding and/or deleting links as recommended. It is contemplated that the device may first evaluate the recommendation against its own internal policies or current conditions before fully committing to the reconfiguration procedure.

Although a specific embodiment for a process 700 for managing recommended multi-link device reconfigurations for carrying out the various steps, processes, methods, and operations described herein is discussed with respect to FIG. 7, any of a variety of systems and/or devices may be utilized in accordance with embodiments of the disclosure. For example, the evaluation of internal capabilities (block 710) could be triggered dynamically in response to a change in the device's power state or application requirements, rather than only at startup. The elements depicted in FIG. 7 may also be interchangeable with other elements of FIGS. 1-6 and FIGS. 8-9 as required to realize a particularly desired embodiment.

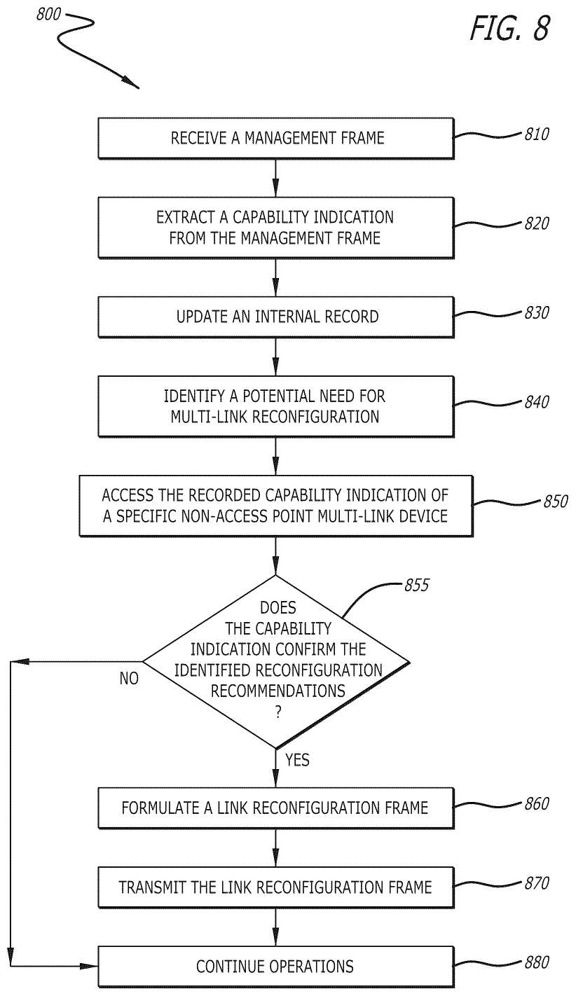

Referring to FIG. 8, a flowchart depicting a process 800 for managing and acting upon multi-link device capability information, in accordance with various embodiments of the disclosure is shown. In many embodiments, the process 800 can receive a management frame (block 810). This management frame can be received from a non-AP MLD during an association process or as part of a periodic capability update. For instance, the frame can contain capability information from the transmitting device that an AP MLD may use to inform its operations.

In a number of embodiments, the process 800 can extract a capability indication from the management frame (block 820). The extracted indication can specifically be a dedicated capability indicator for receiving an access point multi-link device link configuration recommendation. For example, this dedicated capability indicator can be identified as being distinct from a second capability indicator for general multi-link reconfiguration operations to ensure clarity.

In more embodiments, the process 800 can update an internal record (block 830). This update can involve storing the extracted dedicated capability indicator in a data structure, such as the Multi-Link Device Capability Data. It is contemplated that the record can be associated with an identifier for the specific non-AP MLD that sent the management frame, allowing for future retrieval of its specific capabilities.

In further embodiments, the process 800 can identify a potential need for multi-link reconfiguration (block 840). This identification can be based on an analysis of link performance data, such as telemetry indicating network congestion or poor Quality of Service for a specific device. In certain embodiments, the need could also be identified based on network-wide policies for load balancing across different links or frequency bands.

In additional embodiments, the process 800 can access the recorded capability indication of a specific non-access point multi-link device (block 850). This can involve retrieving the status of the dedicated capability indicator for that specific non-AP MLD from the previously updated internal record. For instance, this access can be triggered by the identification of a potential need to send a recommendation to that particular device.

In still more embodiments, the process 800 can determine if the capability indication confirms the identified reconfiguration recommendations (block 855). This determination can specifically involve checking if the non-AP MLD's dedicated capability indicator signals support for receiving the type of recommendation the AP MLD intends to send. However, if the determination reveals that the non-AP MLD does not support receiving recommendations, the process can refrain from formulating a recommendation for that device and instead continue with other operations to avoid an interoperability issue.

In yet further embodiments, the process 800 can formulate a link reconfiguration frame (block 860). The formulated frame can specifically be a Link Reconfiguration Notify frame, which can be designed to carry reconfiguration recommendations from an AP MLD to a non-AP MLD. For example, the content of the frame can be based on the identified need, including details on which links the non-AP MLD should add or delete.

In still additional embodiments, the process 800 can transmit the link reconfiguration frame (block 870). This transmission can be performed only if it is determined that the capability indication confirms the identified reconfiguration recommendations. It is contemplated that the transmission can be an individually addressed frame sent directly to the specific non-AP MLD for which the recommendation was formulated.

In yet more embodiments, the process 800 can continue operations (block 880). This can be the result of a determination that the target non-AP MLD does not support receiving recommendations, in which case normal operations continue without sending the recommendation. In some embodiments, “continuing operations” could also involve logging the unsupported capability of the non-AP MLD for future reference or network analytics.

Although a specific embodiment for a process 800 for managing and acting upon multi-link device capability information for carrying out the various steps, processes, methods, and operations described herein is discussed with respect to FIG. 8, any of a variety of systems and/or devices may be utilized in accordance with embodiments of the disclosure. For example, the identification of a potential need for multi-link reconfiguration (block 840) could be triggered by a machine-learning model analyzing network trends rather than by a static threshold. The elements depicted in FIG. 8 may also be interchangeable with other elements of FIGS. 1-7 and FIG. 9 as required to realize a particularly desired embodiment.

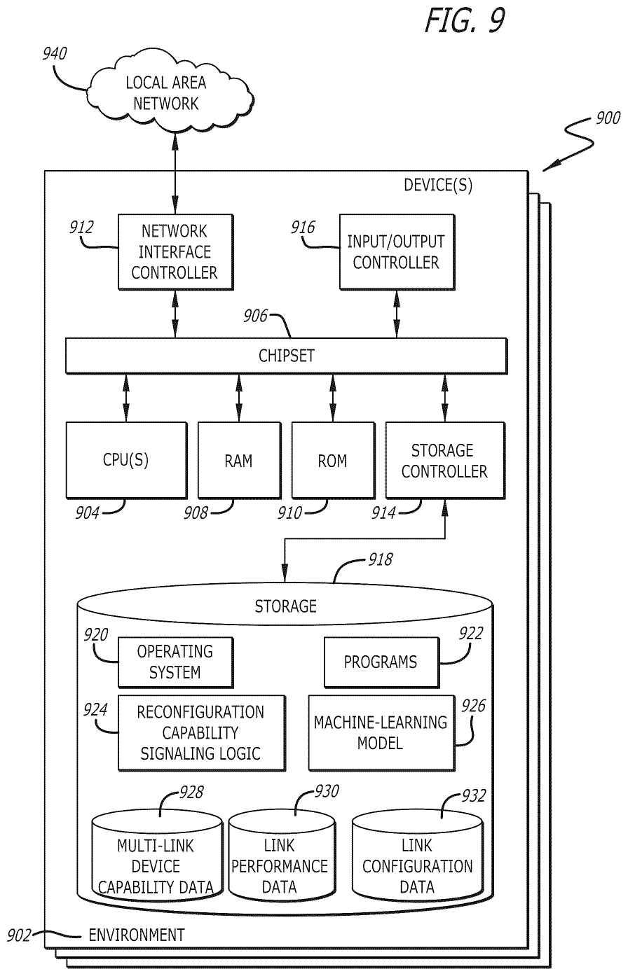

Referring to FIG. 9, a conceptual block diagram of a device 900 suitable for configuration with a reconfiguration capability signaling logic 924, in accordance with various embodiments of the disclosure is shown. The embodiment of the conceptual block diagram depicted in FIG. 9 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 9 can also illustrate an access point, a switch, or a router in accordance with various embodiments of the disclosure. The device 900 may, in many non-limiting examples, correspond to physical devices or to virtual resources described herein.

In many embodiments, the device 900 may include an environment 902 such as a baseboard or “motherboard,” in physical embodiments that can be configured as a printed circuit board with a multitude of components or devices connected by way of a system bus or other electrical communication paths. Conceptually, in virtualized embodiments, the environment 902 may be a virtual environment that encompasses and executes the remaining components and resources of the device 900. In more embodiments, one or more processors 904, such as, but not limited to, central processing units (“CPUs”) can be configured to operate in conjunction with a chipset 906. The processor(s) 904 can be standard programmable CPUs that perform arithmetic and logical operations necessary for the operation of the device 900.

In a number of embodiments, the processor(s) 904 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 906 may provide an interface between the processor(s) 904 and the remainder of the components and devices within the environment 902. The chipset 906 can provide an interface to a random-access memory (RAM 908), which can be used as the main memory in the device 900 in some embodiments. The chipset 906 can further be configured to provide an interface to a computer-readable storage medium such as a read-only memory (ROM 910) or non-volatile RAM (NVRAM) for storing basic routines that can help with various tasks such as, but not limited to, starting up the device 900 and/or transferring information between the various components and devices. The ROM 910 or NVRAM can also store other application components necessary for the operation of the device 900 in accordance with various embodiments described herein.

Additional embodiments of the device 900 can be configured to operate in a networked environment using logical connections to remote computing devices and computer systems through a network, such as the network 940. The chipset 906 can include functionality for providing network connectivity through a network interface card (NIC 912), which may comprise a gigabit Ethernet adapter or similar component. The NIC 912 can be capable of connecting the device 900 to other devices over the network 940. It is contemplated that multiple NICs 912 may be present in the device 900, connecting the device to other types of networks and remote systems.

In further embodiments, the device 900 can be connected to a storage 918 that provides non-volatile storage for data accessible by the device 900. The storage 918 can, for instance, store an operating system 920, applications 922, multi-link device capability data 928, link performance data 930, and link configuration data 932. The storage 918 can be connected to the environment 902 through a storage controller 914 connected to the chipset 906. In certain embodiments, the storage 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 900 can store data within the storage 918 by transforming the physical state of the physical storage units to reflect the information being stored. The specific transformation of physical state can depend on various factors. Examples of such factors can include, but are not limited to, the technology used to implement the physical storage units, whether the storage 918 is characterized as primary or secondary storage, and the like.

In many more embodiments, the device 900 can store information within the storage 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 900 can further read or access information from the storage 918 by detecting the physical states or characteristics of one or more particular locations within the physical storage units.

In addition to the storage 918 described above, the device 900 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 900. In some examples, the operations performed by a cloud computing network, and or any components included therein, may be supported by a device 900 or multiple devices. Stated otherwise, some or all of the operations performed by the cloud computing network, and or any components included therein, may be performed by a device 900 or multiple operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 918 can store an operating system 920 utilized to control the operation of the device 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 918 can store other system or application programs and data utilized by the device 900.

In many additional embodiments, the storage 918 or other computer-readable storage media is encoded with computer-executable instructions which, when loaded into the device 900, may transform it from a general-purpose computing system into a special-purpose computer capable of implementing the embodiments described herein. These computer-executable instructions may be stored as application 922 and transform the device 900 by specifying how the processor(s) 904 can transition between states, as described above. In some embodiments, the device 900 has access to computer-readable storage media storing computer-executable instructions which, when executed by the device 900, perform the various processes described above with regard to FIGS. 1-8. In certain embodiments, the device 900 can also include computer-readable storage media having instructions stored thereupon for performing any of the other computer-implemented operations described herein.

In many further embodiments, the device 900 may include a reconfiguration capability signaling logic 924. The reconfiguration capability signaling logic 924 can be configured to perform one or more of the various steps, processes, and operations described herein for managing the signaling and handling of multi-link reconfiguration capabilities. In some embodiments, when operating on a non-Access Point Multi-Link Device (non-AP MLD), the reconfiguration capability signaling logic 924 can be configured to evaluate the device's internal support for receiving link reconfiguration recommendations. Based on this evaluation, it can set an internal configuration parameter, such as a MIB variable, and subsequently construct a management frame that includes a dedicated capability indicator reflecting this support. It is contemplated that this management frame is then transmitted to an AP MLD to properly advertise its capabilities and enable cooperative network management.

In additional embodiments, when operating on an AP MLD, the reconfiguration capability signaling logic 924 can be configured to receive and process management frames from associated non-AP MLDs. The reconfiguration capability signaling logic 924 can extract the dedicated capability indicator for receiving recommendations and update an internal record, such as the multi-link device capability data 928, with this information for each specific non-AP MLD. Upon identifying a potential need for a link reconfiguration, based on an analysis of network performance, the reconfiguration capability signaling logic 924 can access this recorded capability to determine if the non-AP MLD supports recommendations. If support is confirmed, the reconfiguration capability signaling logic 924 can formulate and transmit a link reconfiguration frame, such as a Link Reconfiguration Notify frame, to the non-AP MLD; otherwise, it can refrain from sending the recommendation to prevent interoperability issues.

In a number of embodiments, multi-link device capability data 928 can comprise detailed information regarding the specific operational capabilities of various multi-link devices within the network. This data can be populated and updated by the reconfiguration capability signaling logic 924 as it receives and parses management frames from associated devices. For instance, the multi-link device capability data 928 can store the status of the dedicated capability indicator for receiving an AP MLD link reconfiguration recommendation for each individual non-AP MLD. The data can be indexed or otherwise associated with unique identifiers for each device, allowing for quick retrieval of specific capability information.

In some embodiments, the multi-link device capability data 928 can also store the status of a second capability indicator for general multi-link reconfiguration operations, allowing the reconfiguration capability signaling logic 924 to clearly distinguish between a device's ability to initiate its own reconfigurations and its ability to process recommendations from an AP. The stored information within the multi-link device capability data 928 can be essential for the decision-making process of an AP MLD, as it provides the necessary context to determine whether sending a reconfiguration recommendation to a particular non-AP MLD is appropriate and supported, thereby ensuring robust and reliable network operation.

In more embodiments, link performance data 930 can comprise real-time or historical telemetry and metrics related to the operational status and quality of the various communication links within the network. This data can include, for example, measurements of link utilization, latency, throughput, packet loss rates, and signal strength for each active link associated with a non-AP MLD. The link performance data 930 can be collected continuously by an AP MLD or other network monitoring components and can provide a dynamic view of the network's health.

In certain embodiments, the reconfiguration capability signaling logic 924 can analyze the link performance data 930 to identify a potential need for a multi-link reconfiguration for a specific device. For instance, if the link performance data 930 indicates that a non-AP MLD's current link is experiencing high latency that negatively impacts an active application, the reconfiguration capability signaling logic 924 may be triggered to recommend a switch to a different, better-performing link. This data can therefore serve as the primary input for an AP MLD to proactively manage network resources and optimize the user experience for its associated devices.

In further embodiments, link configuration data 932 can comprise information that defines the current state of all active link setups for the devices within the network. This data can maintain a record of which non-AP MLDs are associated with an AP MLD, and more specifically, what the current “setup links” are for each of those associated non-AP MLDs. This can include details such as the operating frequency band, channel, and bandwidth for each link in a device's multi-link configuration.

In some embodiments, the link configuration data 932 can provide the essential baseline context for the reconfiguration capability signaling logic 924 when it formulates a link reconfiguration recommendation. By referencing this data, the reconfiguration capability signaling logic 924 can understand the non-AP MLD's current configuration and can therefore determine precisely which links to recommend adding or deleting. Following a successful multi-link reconfiguration procedure, the link configuration data 932 can be updated to reflect the new setup links for the non-AP MLD, ensuring that the AP MLD maintains an accurate and up-to-date representation of the network's topology and device configurations.

In still further embodiments, the device 900 can also include one or more input/output controllers 916 for receiving and processing input from a number of input devices, such as a keyboard, a mouse, a touchpad, a touch screen, an electronic stylus, or other type of input device. Similarly, an input/output controller 916 can be configured to provide output to a display, such as a computer monitor, a flat panel display, a digital projector, a printer, or other type of output device. Those skilled in the art will recognize that the device 900 might not include all of the components shown in FIG. 9 and can include other components that are not explicitly shown in FIG. 9 or might utilize an architecture completely different than that shown in FIG. 9.

As described above, the device 900 may support a virtualization layer, such as one or more virtual resources executing on the device 900. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by one or more machine-learning models 926 (e.g., feature vectors), and or other pre-processing techniques. The one or more machine-learning models 926 may be any type of machine-learning model, such as supervised models, reinforcement models, and/or unsupervised models. The one or more machine-learning models 926 may include one or more of linear regression models, logistic regression models, decision trees, Naïve Bayes models, neural networks, k-means cluster models, random forest models, and/or other types of models.

In further embodiments, the storage 918 can also include a machine-learning model 926. The machine-learning model 926 can be configured to generate inferences by learning from the various data sets available to the device 900, such as the multi-link device capability data 928, the link performance data 930, and the link configuration data 932. In some embodiments, the machine-learning model 926 may be any type of model, such as a supervised, unsupervised, or reinforcement learning model, and can include one or more of linear regression models, logistic regression models, decision trees, neural networks, or random forest models. The machine-learning model 926 may be trained on historical link performance data 930 and the outcomes of past reconfiguration events to recognize patterns that precede network degradation or that indicate opportunities for performance optimization.

It is contemplated that the reconfiguration capability signaling logic 924 can utilize the machine-learning model 926 to enhance its decision-making capabilities. For example, the machine-learning model 926 can analyze real-time link performance data 930 to predict impending link quality degradation or to identify an optimal alternative link for a specific non-AP MLD based on its traffic patterns. The output of the machine-learning model 926 can be an inference that serves as a trigger for the reconfiguration capability signaling logic 924 to identify a potential need for multi-link reconfiguration, thereby initiating the process of validating a non-AP MLD's capabilities and potentially sending a Link Reconfiguration Notify frame.

Although a specific embodiment for a device suitable for configuration with a reconfiguration capability signaling logic 924 for carrying out the various steps, processes, methods, and operations described herein is discussed with respect to FIG. 9, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 9 may also be interchangeable with other elements of FIGS. 1-8 as required to realize a particularly desired embodiment.

Although a specific embodiment for a device suitable for configuration with the networking logic for carrying out the various steps, processes, methods, and operations described herein is discussed with respect to FIG. 4, any of a variety of systems and/or processes may be utilized in accordance with embodiments of the disclosure. For example, the device 400 may be in a virtual environment such as a cloud-based network administration suite, or it may be distributed across a variety of network devices or APs. The elements depicted in FIG. 4 may also be interchangeable with other elements of FIGS. 1-3 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network via a plurality of ports; and
a memory communicatively coupled to the processor, wherein the memory comprises a reconfiguration capability signaling logic that is configured to:
construct a management frame, wherein the management frame comprises at least a dedicated capability indicator for receiving an access point multi-link device link reconfiguration recommendation;
transmit the management frame;
receive a reconfiguration frame;
parse the reconfiguration frame; and
initiate a multi-link reconfiguration procedure associated with the reconfiguration frame.

2. The device of claim 1, wherein the reconfiguration capability signaling logic is further configured to set a reconfiguration parameter prior to constructing the management frame.

3. The device of claim 2, wherein the reconfiguration capability signaling logic is further configured to evaluate one or more internal reconfiguration capabilities prior to setting a reconfiguration parameter.

4. The device of claim 3, wherein the management frame is associated with the reconfiguration parameter.

5. The device of claim 1, wherein the reconfiguration capability signaling logic is further configured to monitor for incoming frames on the plurality of ports until a reconfiguration frame is received.

6. The device of claim 1, wherein the dedicated capability indicator is distinct from a second capability indicator for general multi-link reconfiguration operations.

7. The device of claim 1, wherein the dedicated capability indicator is located within a Multi-Link Device (MLD) Capabilities and Operations subfield of the management frame.

8. The device of claim 1, wherein the dedicated capability indicator is located within an Extended Multi-Link Device (MLD) Capabilities and Operations subfield of the management frame.

9. The device of claim 2, wherein the reconfiguration parameter is a Management Information Base (MIB) variable.

10. The device of claim 1, wherein the received reconfiguration frame is a Link Reconfiguration Notify frame.

11. A device, comprising:
a processor;
at least one network interface controller configured to provide access to a network via a plurality of ports; and
a memory communicatively coupled to the processor, wherein the memory comprises a reconfiguration capability signaling logic that is configured to:
receive a management frame;
extract a dedicated capability indicator for receiving an access point multi-link device link configuration recommendation from the management frame;
update an internal record;
identify a potential need for multi-link reconfiguration;
access a record capability indication of a specific non-access point multi-link device;
formulate a link reconfiguration frame; and
transmit the link reconfiguration frame.

12. The device of claim 11, wherein the reconfiguration capability signaling logic is further configured to determine if the dedicated capability indicator indicates that the specific non-access point multi-link device supports receiving link configuration recommendations prior to formulating the link reconfiguration frame.

13. The device of claim 12, wherein the reconfiguration capability signaling logic is further configured to transmit the link reconfiguration frame only if it is determined that the dedicated capability indicator indicates that the specific non-access point multi-link device supports receiving link configuration recommendations.

14. The device of claim 11, wherein the dedicated capability indicator is distinct from a second capability indicator for general multi-link reconfiguration operations.

15. The device of claim 11, wherein the dedicated capability indicator is located within a Multi-Link Device (MLD) Capabilities and Operations subfield of the management frame.

16. The device of claim 11, wherein the dedicated capability indicator is located within an Extended Multi-Link Device (MLD) Capabilities and Operations subfield of the management frame.

17. The device of claim 11, wherein identifying the potential need for multi-link reconfiguration is based on an analysis of link performance data.

18. The device of claim 11, wherein the formulated and transmitted link reconfiguration frame is a Link Reconfiguration Notify frame.

19. A method of managing recommended multi-link device reconfigurations, the method comprising:
constructing a management frame, wherein the management frame comprises at least a dedicated capability indicator for receiving an access point multi-link device link reconfiguration recommendation;
transmitting the management frame;
receiving a reconfiguration frame;
parsing the reconfiguration frame; and
initiating a multi-link reconfiguration procedure associated with the reconfiguration frame.

20. The method of claim 19, wherein the dedicated capability indicator is distinct from a second capability indicator for general multi-link reconfiguration operations.
